(19) United States
(12) Patent Application Publication
(10) Pub. No.: US 2021/0035200 A1
(43) Pub. Date: Feb. 4, 2021

(54) PRODUCT SELLING VALUE SHARING SYSTEM, METHOD THEREFOR, AND PROGRAM THEREFOR

(71) Applicant: DADA INTEGRATE CO., LTD., Osaka-shi, Osaka (JP)

(72) Inventor: Masaki KAKISAKA, Osaka-shi Osaka (JP)

(21) Appl. No.: 17/043,828

(22) PCT Filed: Apr. 1, 2019
(86) PCT No.: PCT/JP2019/014563

§ 371 Date: Sep. 30, 2020

(30) Foreign Application Priority Data
Mar. 30, 2018 (JP) 2018-067774

(51) Int. Cl. G06Q 30/06; G06Q 10/08

(52) U.S. Cl. CPC G06Q 30/0643; G06Q 10/083

(57) ABSTRACT

Provided is a product selling value sharing system 1 that returns a profit to also a salon and a staff member when a guest purchases a product. The product selling value sharing system 1 includes: an inviting functional unit 52 and an invited functional unit 53 that associate a guest with some of a plurality of salons or staff members; a product list display section 213 that allows a user terminal 4 accessed through the Internet 6 to display a plurality of products; and an order receiving functional unit 74 that receives purchase of a product displayed by the product list display section 213 performed by operation of the guest on the user terminal 4, the order receiving functional unit 74 including processing units that receive and implement purchase of a product by the guest and that include a point sharing functional unit 76 for allowing the corresponding salons or/and staff members associated with the guest, and a manufacturer of the product, to share at least a partial value of a price of the product, and an order-data manufacturer transfer functional unit 75 for transmitting shipping instruction data on the product to the manufacturer of the product.

### TECHNICAL FIELD

The present invention relates to a product selling value sharing system, a method for product selling value sharing, and a program for product selling value sharing, allowing a product guided in a store to be purchased through the Internet, for example.

### BACKGROUND ART

Salons such as beauty salons conventionally provide customers with beauty products such shampoos and hair wax that are not generally distributed. Such beauty products dedicated to salons are provided allowing the beauty products to be purchased only at the salons, so that users generally purchase them when visiting the salons.

In recent years, distribution through the Internet has been developed, so that not only corporations specializing in product sales but also individuals can easily sell products on the Internet. This causes a situation in which a salon manager, having excess inventories of the above-mentioned beauty products dedicated to salons, sells them cheaply through the Internet. This situation causes a vicious cycle in which values of products dedicated to purchase at only salons deteriorate to cause a price collapse, and then a customer appears not to purchase a product at a list price.

Even when a salon manager introduces good beauty products to a customer, sales through the Internet as described above causes the customer to purchase them on the Internet instead of purchase at the salon. This causes the salon manager having introduced the products to earn no profit. As a result, although manufacturers of the beauty products may be profitable, nothing may be returned to the manager of the salon, having focused on product sales.

Investigation results of a technique related to product sales in such a salon show that a point service providing method in the beauty industry and the like has been proposed (see Patent Literature 1). This point service provision method allows a customer to search for a product advertised in a terminal of a beauty salon and an actual store allowing the product to be purchased, during waiting time for perming or coloring at the beauty salon, and then allows a point of purchase to be distributed to the customer, the beauty salon, and the store when the customer purchases the product. Unfortunately, this system is effective only for purchase while the customer is in the beauty salon, and cannot provide a point when the customer leaves the beauty salon and purchases the product through the Internet at another place.

### CITATION LIST

### Patent Literature

Patent Literature 1: JP 2003-030520 A

### SUMMARY OF THE INVENTION

### Technical Problems

In view of the above problems, an object of the present invention is to provide a product selling value sharing system, a method for product selling value sharing, and a program for product selling value sharing, allowing a profit to be also returned to a store or/and staff member in a position to propose a product when a customer purchases the product, and thus improving satisfaction of an owner of the store and/or the staff member.

### Solution to Problems

The present invention provides a product selling value sharing system including: storage means for storing store data on a plurality of stores, staff member data on one or more staff members associated with the corresponding plurality of stores, customer data on a plurality of customers, and product data on a plurality of products; associating means for associating the customers with some of the plurality of stores or staff members; product multiple display means for allowing the plurality of products to be displayed in a user terminal that accesses the product selling value sharing system through a telecommunication line; product purchase receiving means for receiving operation on the user terminal by the customer to purchase the corresponding products displayed by the product multiple display means, the product purchase receiving means being provided with processing units that receive and implement purchase of a product by the customer and that include a value sharing processing unit for allowing the corresponding stores or/and staff member associated with the customer, and a supplier of the product, to share at least a partial value of a price of the product, and a shipping instruction processing unit for transmitting shipping instruction data on the product to the supplier of the product; and purchase-without-association restriction means for restricting purchase of the customer with no association performed by the associating means when the customer tries to purchase a product using the product purchase receiving means, and the customer is not directly or indirectly associated with corresponding stores or staff member by the associating means.

### Advantageous Effects of Invention

The present invention enables providing the product selling value sharing system, the method for product selling value sharing, and the program for product selling value sharing, allowing a profit to be also returned to a store or/and staff member in a position to propose a product when a customer purchases the product.

### BRIEF DESCRIPTION OF THE DRAWINGS

FIG. 1 is a block diagram illustrating a system configuration of a product selling value sharing system.

FIG. 2 is an explanatory diagram for illustrating a user type and a hierarchical structure of user.

FIG. 3 is an explanatory diagram of corporate type master data, user type master data, and user-specific setting data.

FIG. 4 is an explanatory diagram of user data, salon data, and salon data.

FIG. 5 is an explanatory diagram of point usage attribute data, point issue type setting data, and profit sharing data.

FIG. 6 is a functional block diagram of a control unit of a user terminal.

FIG. 7 is an explanatory diagram of a screen displayed on a display of a user terminal.

FIG. 8 is an explanatory diagram of a screen displayed on a display of a user terminal.

FIG. 9 is a functional block diagram of a shopping functional unit.

FIG. 10 is an explanatory diagram of a screen displayed by a shopping page display functional unit.

FIG. 11 is a functional block diagram of a salon management functional unit.

### DESCRIPTION OF EMBODIMENTS

Hereinafter, an embodiment of the present invention will be described with reference to the drawings.

### Embodiment 1

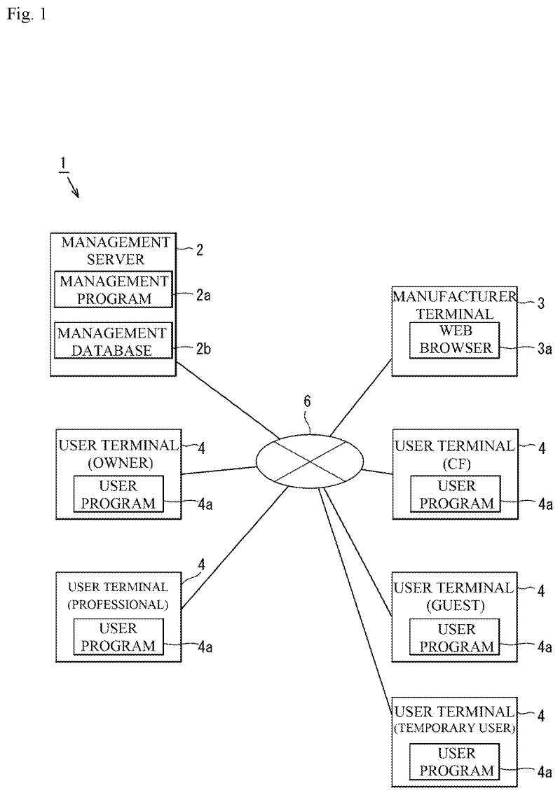

FIG. 1 is a block diagram illustrating a system configuration of a product selling value sharing system 1.

The product selling value sharing system 1 is configured by connecting a management server 2, a plurality of manufacturer terminals 3, and a plurality of user terminals 4 to the Internet 6.

The management server 2 is composed of a server computer including hardware elements such as: a control unit composed of a CPU, a ROM, a RAM, and the like, to execute various arithmetic operations and control operations; a storage unit composed of a hard disk, a flash memory, or the like, to allow reading and writing information; an input unit composed of a touch panel, a keyboard, a mouse, a push button, or some of these components to receive input by a contact operation; a display composed of a liquid crystal display, an organic EL display, or the like to display an image such as a character or a figure; and a communication unit composed of a LAN board, a WiFi unit, or the like to execute wired or wireless communication. The storage unit stores a management program 2a and a management database 2b (storage means). This allows the control unit of the management server 2 to operate according to the management program 2a while the control unit appropriately refers to and updates data stored in the management database 2b.

The manufacturer terminal 3 is used as a terminal for managing products provided by a manufacturer (supplier). The manufacturer terminal 3 is composed of a personal computer including hardware elements such as: a control unit composed of a CPU, a ROM, a RAM, and the like, to execute various arithmetic operations and control operations; a storage unit composed of a hard disk, a flash memory, or the like, to allow reading and writing information; an input unit composed of a touch panel, a keyboard, a mouse, a push button, or some of these components to receive input by a contact operation; a display composed of a liquid crystal display, an organic EL display, or the like to display an image such as a character or a figure; and a communication unit composed of a LAN board, a WiFi unit, or the like to execute wired or wireless communication. The storage unit stores a web browser 3a. This allows the control unit of the manufacturer terminal 3 to operate according to the WEB browser 3a while the control unit appropriately refers to and updates manufacturer data (not illustrated) on the manufacturer terminal 3 and product data (not illustrated) stored in the management database 2b.

The user terminal 4 is composed of a mobile information terminal such as a smartphone, including: a control unit that performs various controls; a storage unit that stores data; an input unit that receives an input using a touch panel or/and a press button; a display for displaying an image and a characters; a photographing unit for obtaining a still image or a moving image by photographing with a camera; a voice input unit composed of a microphone to receive voice input; a voice output unit composed of a speaker to output voice; and a communication unit for performing wireless communication. The storage unit stores a user program 4a. This allows the control unit of the user terminal 4 to operate according to the user program. There is the plurality of user terminals 4 installed with the user program 4a, operating in different ways depending on types of user using the respective user terminals 4, such as an owner of a salon, a professional being an employee of a salon, a CF being a family or the like of an owner or a professional of a salon, a guest being a customer of a salon or staff member (hereinafter, staff member refers to both of an owner and a professional), and a temporary user having not registered corresponding to any of them. The types of user are identified by a login ID or the like.

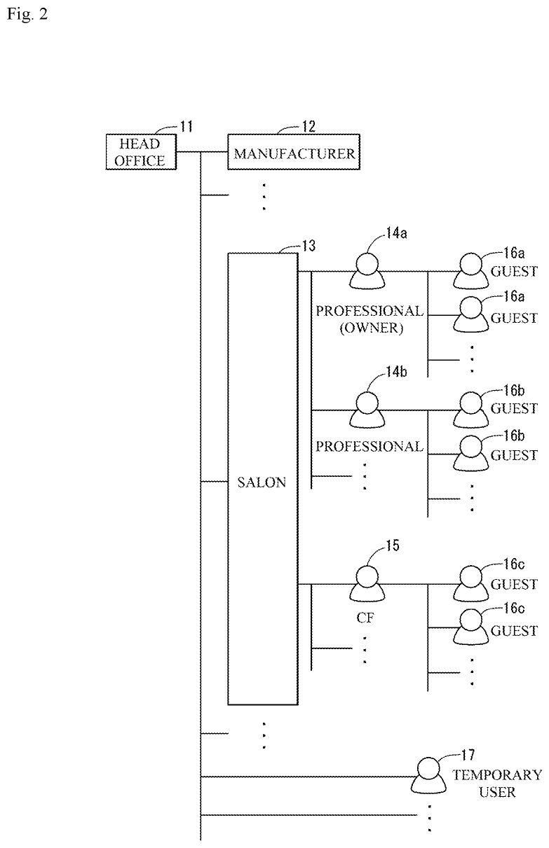

FIG. 2 is an explanatory diagram for illustrating a user type and a hierarchical structure of user using the product selling value sharing system 1.

The product selling value sharing system 1 is totally managed by a head office 11 using the management server 2 (see FIG. 1). The illustrated example shows corporations including the head office 11, a salon 13 such as a beauty salon, and a manufacturer 12 that manufactures a product sold at the salon, and individuals including an owner 14a, a professional 14b, a CF 15, guests 16a, 16b, and 16c, and a temporary user 17.

Under the head office 11, a plurality of manufacturers 12 and a plurality of salons 13 are connected. Temporary users having just installed the user program 4a (see FIG. 1) are also connected under the head office 11.

The manufacturer 12 is in charge of registration of products to be sold, inventory management, shipping work, and the like, and updates product data (not illustrated) of the management server 2 managed by the head office 11.

The salon 13 registers information about its store in the management server 2 of the head office 11, and also associates staff member 14 (14a, 14b) such as the owner 14a and the professional 14b under the salon 13, and the CF 15 under the salon 13.

The owner 14a associates guests 16a of the owner, including a customer of the owner itself, a customer to whom the owner has introduced the product selling value sharing system 1, and a customer of the salon 13, under the owner 14a.

The professional 14b associates guests 16b of a professional, including a customer of the professional 14b being a staff member other than the owner, and a customer to whom the professional 14b has introduced the product selling value sharing system 1, under the professional 14b.

The CF 15 is associated with the salon 13 to which the owner 14a and the professional 14b belong when being introduced to the owner 14a or the professional 14b, and an associate, a friend, and the like of the CF 15 are associated under the CF 15, as guests 16c.

Although the guests 16a, 16b, and 16c associated with the owner 14a, the professional 14b, and the CF 15, respectively, can purchase products in the product selling value sharing system 1, the temporary user 17 being not associated with any of them cannot purchase a product in the product selling value sharing system 1 while being allowed to browse the product. A value caused by purchasing a product is shared in accordance with this association. Details will be described below.

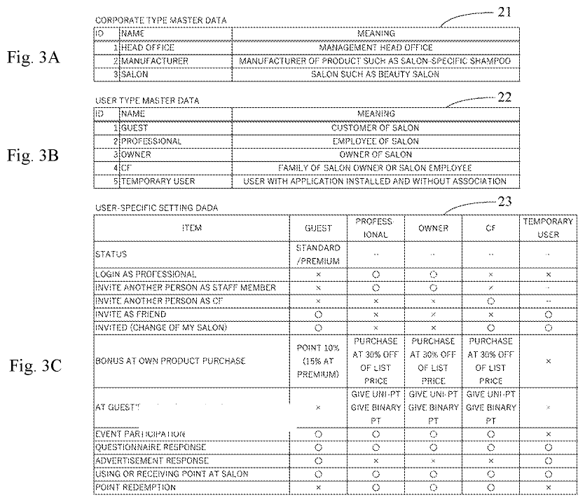

FIGS. 3, 4, and 5 are each an explanatory view for illustrating a part of various data stored in the management database 2b.

FIG. 3(A) illustrates corporate type master data 21 that is used to manage corporate types such as a head office, a manufacturer, and a salon.

FIG. 3(B) illustrates user type master data 22 that is used to manage a user types, such as a guest, a professional, an owner, a CF, and a temporary user.

FIG. 3(C) illustrates user-specific setting data 23 that is used to manage whether each item is executed for each user type of the user type master data 22. This user-specific setting data 23 stores setting of each of items for each user type, the items including a status, login as a professional, inviting another person as staff member, inviting another person as a CF, an invitation as a friend, being invited (change of MY salon), a bonus at own purchase of a product, when a guest purchases a product, event participation, a questionnaire response, an advertisement response, using or receiving a point at a salon, and points redemption.

Operation described in each item is indicated as “o” when being executable, and is indicated as “x” when being not executable. Characters in each item indicate setting of the item. “Uni PT” means a “unique point” and indicates a point unique to a user. “Binary PT” means a “binary point” and indicates a point like an affiliate that is not unique to a user but is distributed to all users.

The user-specific setting data 23 specifies contents of each item, executable by users of respective user types, and thus executable contents are determined for each of a guest, a professional, an owner, a CF, and a temporary user.

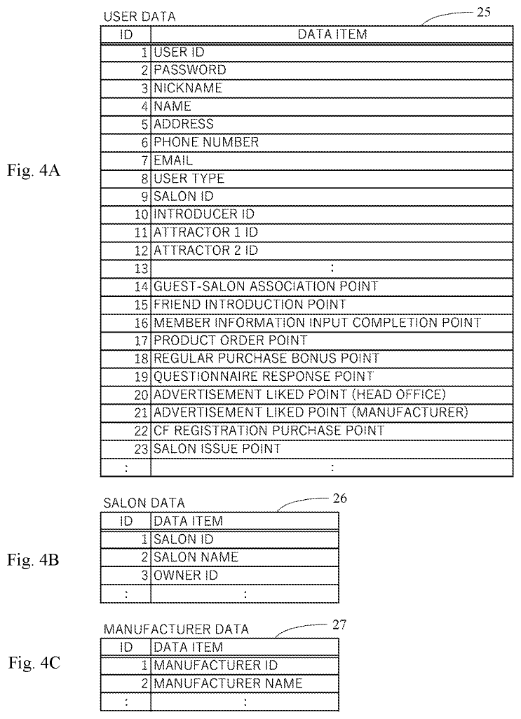

FIG. 4(A) shows user data 25 that includes items such as a user ID, a password, a nickname, a name, an address, a phone number, an Email, a user type, a salon ID, an introducer ID, an attractor 1 ID, an attractor 2 ID, . . . , a guest-salon association point, a friend introduction point, a member information input completion point, a product order point, a regular purchase bonus point, a questionnaire response point, an advertisement liked point (head office), an advertisement liked point (manufacturer), a CF registration purchase point, and a salon issue point.

The item, “introducer ID” stores a user ID of a user having introduced a corresponding user, and examples of the user ID include user IDs of an owner, a professional, a CF, a guest, and the like, having introduced the product selling value sharing system 1 to the corresponding user.

The items, “attractor 1 ID”, “attractor 2 ID”, . . . , each store a user ID of a user introduced by and associated with a user of the corresponding one of the items, i.e., a user ID of the user introduced.

Each of point items stores a total number of points given by performing action indicated by corresponding one of item names. The points stored in this way decrease when used, and increase when action of the corresponding one of item names is performed.

Data on a user of a user type of an owner or a professional is staff member data, data on a user of a user type of a guest is customer data, and data on a user of a user type of a CF is relative user data on relatives of staff member.

FIG. 4(B) shows salon data 26 (store data) that includes items related to a salon, such as a salon ID, a salon name, an owner ID, a location and a contact address of a salon.

FIG. 4(C) shows manufacturer data 27 that includes items related to a manufacturer, such as a manufacturer ID, a manufacturer's name, and a location and a contact address of the manufacturer.

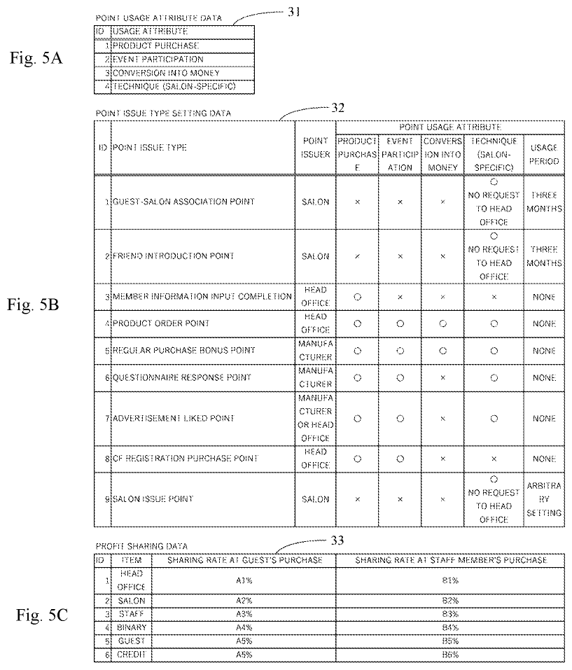

FIG. 5(A) shows point usage attribute data 31 that includes registered data indicating point usage attributes such as product purchase, event participation, conversion into money, and technique (salon-specific).

FIG. 5(B) shows point issue type setting data 32 that includes a point issuer, a point usage attribute, and a usage period, for each of point issue types such as the guest-salon association point, the friend introduction point, the member information input completion point, the product order point, the regular purchase bonus point, the questionnaire response point, the advertisement liked point, the CF registration purchase point, and the salon issue point.

The item, “point usage attribute” indicates whether a point can be used for each of the point usage attributes of the product purchase, the event participation, the conversion into money, and the technique, using “o” or “x”. The technique is an item unique to a salon, and refers to a technical service (such as shampoo, coloring, perming, or the like) available at the salon (i.e., the salon associated with a user). The service at the salon can be used using a point available for the technique. The item described as “no request to head office” indicates that the head office is not required to bear a burden on the point because the point is for allowing the salon to provide the service.

The item, “usage period” stores a period (usage limitation period) in which a point of a point issue type can be used. “None” indicates that there is no limitation on the period of use, and “arbitrary setting” indicates that the salon can arbitrarily set.

FIG. 5(C) shows profit sharing data 33 that shows how profit of sales of product purchase is shared. The profit sharing data 33 includes a sharing rate at the time of customer's purchase and a sharing rate at the time of staff member's purchase that are defined for each of items such as a head office, a salon, staff member, a binary, a guest, and credit. This enables the amount of money to be different between purchase made by a guest being a customer and purchase made by staff member being an owner or a professional.

Besides this, the management database 2b stores various data. For example, product data (not shown) includes not only a product name, a price, a product description, but also a manufacturer ID, so that a manufacturer providing a product and the product are associated with each other.

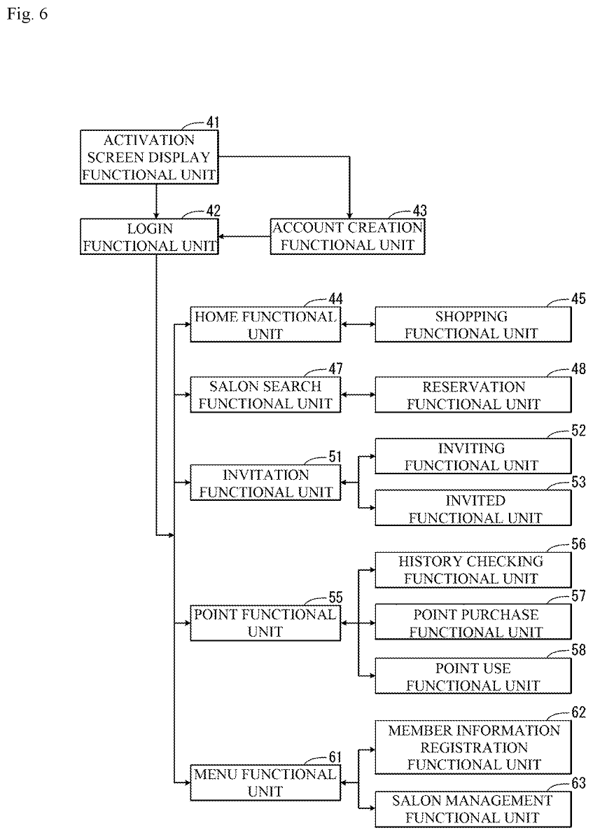

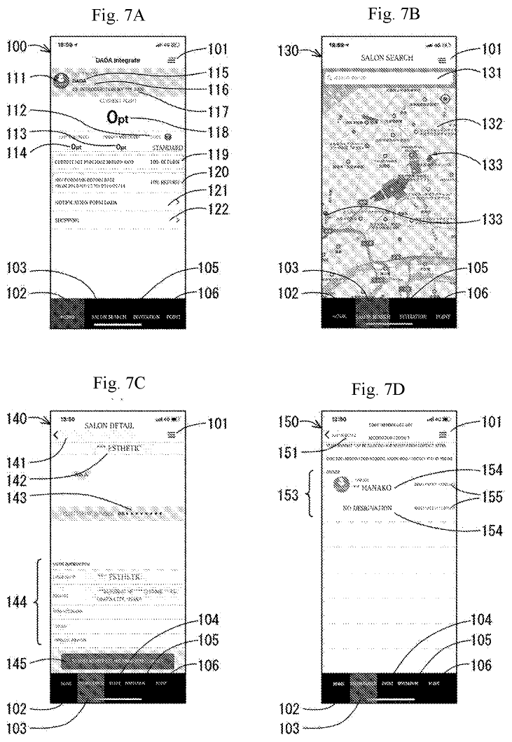

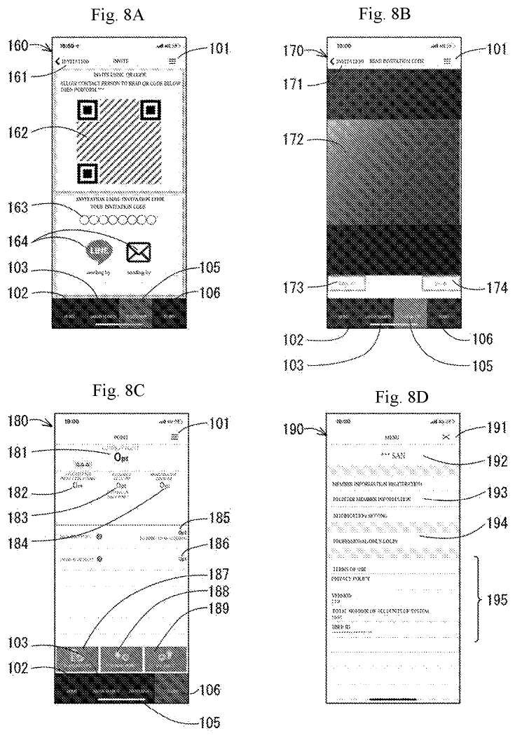

FIG. 6 is a functional block diagram of functions of a control unit of the user terminal 4 (see FIG. 1) operated according to the user program 4a. FIGS. 7 and 8 are each an explanatory diagram of a screen displayed on a display of the user terminal 4.

When the user program 4a is activated, the control unit of the user terminal 4 causes an activation screen display functional unit 41 to display an activation screen (not illustrated), and allows a user to select login or account creation.

When the login is selected, the control unit of the user terminal 4 causes a login functional unit 42 to require input of a user ID and a password, and authenticates whether the input user ID and password are registered in the user data 25 (see FIG. 4(A)). When they are registered, a home screen 100 of FIG. 7(A) is displayed.

When the account creation is selected, the control unit of the user terminal 4 causes an account creation functional unit 43 to require input of a user ID, a password, and a nickname. When the input user ID is not registered in the user data 25 (see FIG. 4(A)), the account creation is accepted to create a new account. Then, the login functional unit 42 accepts the login authentication and displays the home screen 100 of FIG. 7(A).

A HOME functional unit 44 functions on the home screen 100, and executes each function displayed on the home screen 100.

The home screen 100 includes a menu button 101 for displaying a menu screen 190 (see FIG. 8(D)), a user type display section 111 for indicating whether a user type is a guest, a professional, an owner, a CF, or a temporary user, a salon name display section 115 for displaying an associated salon name (a head office when no salon is associated), a nickname display section 116 for displaying a nickname of a user, and an introducer display section 117 for displaying an introducer of the user.

The home screen 100 also includes a current point display section 118 for displaying a current point, a stage display section 112 for displaying whether a stage is standard or premium, a GET point present-month display section 113 for displaying a point acquired in the present month, and a GET point last-month display section 114 for displaying a point acquired in the last month.

The home screen 100 further includes a current net purchase return rate 119, a present-month purchase return rate 120 in a predetermined period, a notification display section 121 from a salon (a notification display section from the head office when no salon is associated), and a shopping function transfer unit 122 that allows transfer to shopping using a shopping functional unit 45 (see FIG. 6) that enables a product to be purchased.

The home screen 100 is provided in its lower portion with buttons common to each screen, such as a HOME button 102 for transfer to the home screen 100, a salon search button 103 for transfer to a salon search screen 130 (see FIG. 7(B)), an invitation button 105 for transfer to a selection screen (not illustrated) for selecting inviting or being invited, and a point button 106 for transfer to a point-check screen 180 (see FIG. 8(C)).

In the following description, an element identical to that in a screen that have already been described is designated by the same reference numeral and duplicated detailed description thereof is eliminated.

A salon search functional unit 47 (see FIG. 6) functions in the salon search screen 130 illustrated in FIG. 7(B), a salon detail screen 140 illustrated in FIG. 7(C), and a staff member-list and reservation screen 150 illustrated in FIG. 7(D), and executes each of functions displayed on the salon search screen 130, the salon detail screen 140, and the staff member-list and reservation screen 150.

The salon search screen 130 shown in FIG. 7(B) displays a search condition input section 131 for inputting an address, a station, and the like to search for a salon in the vicinity thereof, a map display section 132 for displaying a search result and a map of a current location, and a salon position display mark 133 indicating a position of the salon on the map displayed on the map display section 132. When the salon position display mark 133 is selected, the screen transfers to the salon detail screen 140 (see FIG. 7(C)) illustrating detailed information about the salon.

The salon detail screen 140 shown in FIG. 7(C) is a screen for displaying information about the salon selected on the salon search screen 130 described above. The salon detail screen 140 includes a previous screen button 141 for return to the salon search screen 130, a salon name display section 142 indicating a salon name, a salon phone number display section 143 indicating a salon phone number, a salon detailed information display section 144 for displaying detailed information on a salon, such as a name, an address, business hours, access, and a URL of an official website (official homepage), and a staff member-list and reservation 145 that transfers to the staff member-list and reservation screen 150 (see FIG. 7(D)) of the salon.

The staff member-list and reservation screen 150 shown in FIG. 7(D) includes a staff member list display section 153 for displaying a list of staff member (an owner and a professional) of a selected salon and “no designation”. The staff member list display section 153 includes a name display section 154 illustrating a name of staff member and an attribute (an owner or not) of the staff member, and a reservation button 155 for making a reservation for the staff member at the salon, which are displayed for each staff member. The name display section 154, listing a plurality of names and attributes, displays one item of “no designation”. Selecting the reservation button 155 of the “no designation” enables a reservation for the salon without designating staff member.

After the reservation button 155 is selected, a reservation screen (not shown) for selecting a date and time and a service for a reservation is displayed. This reservation screen can be in an appropriate format such as a calendar format or a format for inputting or selecting a date and time in characters. A reserved person (guest), a reserved date and time, and designated staff member, using the reservation screen, are registered as reservation data in the management database 2b of the management server 2 (see FIG. 1) for each salon. Then, an owner or a professional can find out the reservation when transferring to a salon management functional unit 63 (see FIG. 6) using a professional-ONLY-login button 194 described below (see FIG. 8(D)).

An invitation functional unit 51 (see FIG. 6) displays a screen for selecting inviting or being invited (not illustrate) to allow a user to select inviting or being invited. According to the selection, the invitation functional unit 51 allows an inviting functional unit 52 (associating means) to serve to display an invitation screen 160 shown in FIG. 8(A), or allows an invited functional unit 53 (associating means) to serve to display a being-invited screen 170 shown in FIG. 8(B), and then executes each of functions displayed on the invitation screen 160 and the being-invited screen 170.

The invitation screen 160 shown in FIG. 8(A) includes a previous screen button 161 for return to the screen for selecting inviting or being invited, a code image display section 162 for displaying a QR code (registered trademark) of a user to be invited, an invitation code display section 163 for displaying an invitation code of the user to be invited, and a download address transmission button 164 that is used to notify an address (a home page address, an address to access an application download screen on the Apple store or Google Play, or the like) for downloading the user program 4a (see FIG. 1) using notification means such as an SNS or an email.

The being-invited screen 170 shown in FIG. 8(B) includes a previous screen button 171 for return to the screen for selecting inviting or being invited, a photographed image display section 172 for reading a QR code (registered trademark) using a photographing unit (camera), a cancel button 173 for canceling, and a stop button 174 for stopping.

A point functional unit 55 (see FIG. 6) functions on the point-check screen 180 shown in FIG. 8(C), and executes each of functions displayed on the point-check screen 180.

The point-check screen 180 shown in FIG. 8(C) includes a current point display section 181 for displaying a total number of points owned by a user, a product-purchase current point display section 182 for displaying the number of points available for product purchase, a salon current point display section 183 for displaying the number of points available for salon services, a seminar point display section 184 for displaying the number of points available for a seminar, a head office issued point display section 185 for displaying the number of points issued by the head office, being available for all products and services, and a salon issued point display section 186 for displaying the number of points issued by a salon associated with the user itself, being available at only the salon.

Here, each point is displayed by totalizing points as follows.

The current point display section 181 displays a total value of all points stored as its own data in the user data 25 (see FIG. 4(A)).

The product-purchase current point display section 182 displays a total value of points of point issue types each having a point usage attribute of the “product purchase” indicating “o” in the point issue type setting data 32 (see FIG. 5(B)) of own points stored in the user data 25 (see FIG. 4(A)).

The salon current point display section 183 displays a total value of points of point issue types each having a point usage attribute of the “technique” indicating “o” in the point issue type setting data 32 (see FIG. 5(B)) of own points stored in the user data 25 (see FIG. 4(A)).

The seminar point display section 184 displays a total value of points of point issue types each having a point usage attribute of the “event participation” indicating “o” in the point issue type setting data 32 (see FIG. 5(B)) of own points stored in the user data 25 (see FIG. 4(A)).

The head office issued point display section 185 displays a total value of points of point issue types each indicating a point issuer of the “head office” in the point issue type setting data 32 (see FIG. 5(B)) of own points stored in the user data 25 (see FIG. 4(A)).

The salon issued point display section 186 displays a total value of points of point issue types each indicating a point issuer of the “salon” in the point issue type setting data 32 (see FIG. 5(B)) of own points stored in the user data 25 (see FIG. 4(A)).

The point-check screen 180 also includes a point use history display button 187 for transfer to a history checking functional unit 56 (see FIG. 6) for displaying a past point use history, a point purchase screen display button 188 for transfer to a point purchase functional unit 57 (see FIG. 6) for purchasing a point, and a point use screen display button 189 for transfer to a point use functional unit 58 (see FIG. 6) for using a point.

The point use functional unit 58 (see FIG. 6) includes appropriate buttons such as a button for transfer to the shopping functional unit 45 (see FIG. 6), a button for transfer to a screen allowing an event such as a seminar to be selected, and a button for transfer to a screen allowing a service (shampoo, massage, coloring, perming, cutting, or the like) at a salon to be selected, and thus allows guest's operation to enable a point for limited use and a point for unlimited use to be used in an available application set in the point issue type setting data 32 (see FIG. 5).

A menu functional unit 61 (see FIG. 6) functions on the menu screen 190 shown in FIG. 8(D), and executes each of functions displayed on the menu screen 190.

The menu screen 190 shown in FIG. 8(D) includes a previous screen button 191 for return to a previous screen by closing the menu screen, a nickname display section 192 for displaying a user's nickname, a member information registration transfer unit 193 for transfer to a member information registration functional unit 62 (see FIG. 6) in which information on a user itself is displayed and selected as a member information, a professional-ONLY-login button 194 for transfer to a salon management functional unit 63 (see FIG. 6) that can be used only by an owner and a professional, and a system information display section 195 for displaying information about the product selling value sharing system 1 (see FIG. 1) and the management program 2a (see FIG. 1), such as terms of use and a version of the program.

The member information registration functional unit 62 (see FIG. 6) receives input of necessary information such as a name and an address of a user, and registers the information in the user data 25 (see FIG. 4(A)).

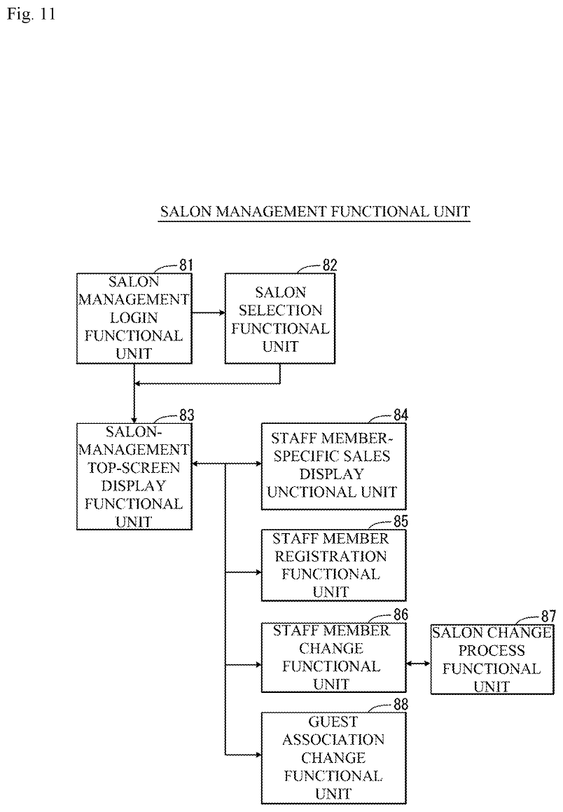

The salon management functional unit 63 will be described later with reference to FIG. 11.

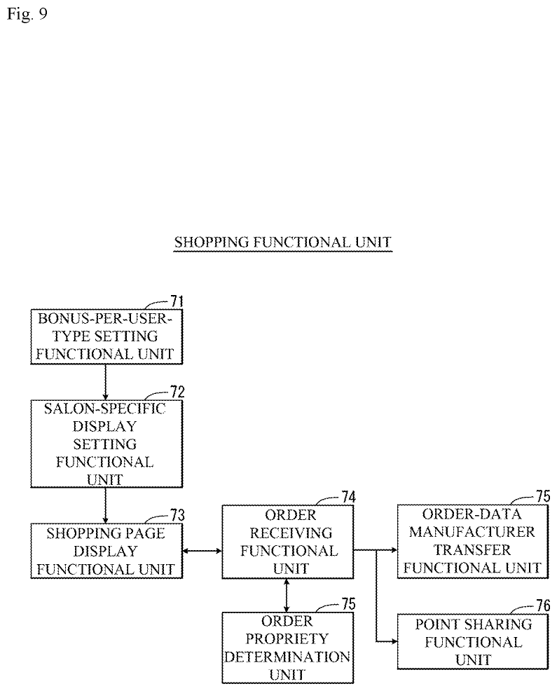

FIG. 9 is a functional block diagram illustrating various functions of the shopping functional unit 45 (see FIG. 6).

The shopping functional unit 45 first operates to allow a bonus-per-user-type setting functional unit 71 to set a bonus, which is to be displayed when a product is displayed, to be different for each user type in the user-specific setting data 23 (see FIG. 3(C)). Specifically, when a user is an owner, a professional, or a CF, the bonus is to purchase a product at a price reduced by 30% from its fixed price, and when the user is a guest, the bonus is to receive a part of the product price as a point. When a guest is in a standard status, a point of 10% can be obtained, and when the guest is in a premium status, a point of 15% can be obtained.

Next, a salon-specific display setting functional unit 72 operates to set display contents set for a salon associated with an operating user to be displayed in a portion for changing display contents for each salon on a screen allowing shopping. When a temporary user without being associated, or a user associated with a salon for which salon-specific display contents are not set, operates, display contents prepared and set in common by the head office are set to be displayed.

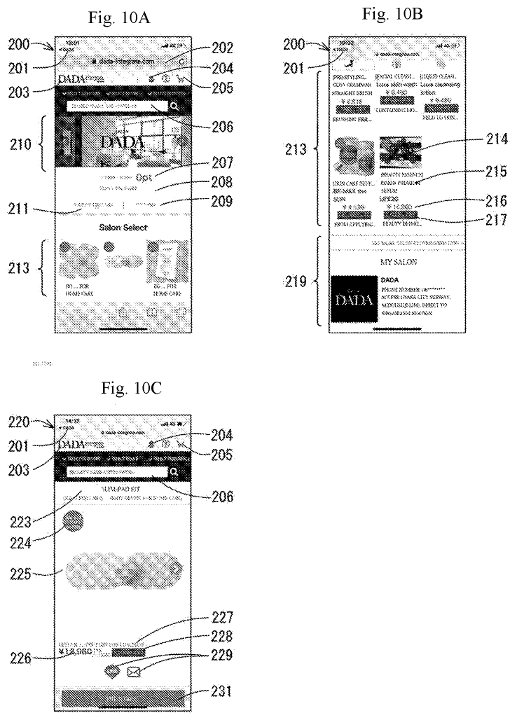

Subsequently, a shopping page display functional unit 73 serves to display a shopping screen 200 shown in FIGS. 10(A) and 10(B). This shopping screen 209 extends continuously from an upper portion illustrated in FIG. 10(A) to a lower portion illustrated in FIG. 10(B), and is configured to allow scroll display in a vertical direction.

The shopping screen 200 shown in FIG. 10(A) includes a previous screen button 201 for return to the previous screen, an address display section 202 for displaying an address of a shopping site, a salon-specific title display section 203 (display section for each store) for displaying a title such as a salon name or a salon logo, a user data display button 204 for displaying contents registered as user data, a shopping cart button 205 for displaying a list of products placed in a shopping cart and advancing purchase operation, a salon-specific image display section 210 (store-specific display section) for displaying a main image such as an in-store photo for each salon, a current point display section 207 for displaying a total value of current owned points, a status display section 208 for displaying a current status for a user being a guest, a shopping history display button 211 for displaying past shopping history, a nickname display section 209 for displaying a user's nickname, a product list display section 213 (product multiple display means, a common product display section) for displaying a list of purchasable products, and a salon data display section 219 (store-specific display section) for displaying a name, a telephone number, an access method, or an address of an associated salon, as shown in FIG. 10(B).

The product list display section 213 displays a product image display section 214, a product name display section 215, a price display section 216, and a bonus display section 217 (user type-specific bonus display section), for each product. Contents in the product image display section 214, the product name display section 215, and the price display section 216 are acquired from product data (not shown) stored in the management database 2b (see FIG. 1).

The bonus display section 217 displays contents acquired such that a bonus of an accessed user is grasped with reference to the “bonus at own purchase of a product” in the user-specific setting data 23 (see FIG. 3(C)) corresponding to the user types in the user data 25 (see FIG. 4), and the bonus is applied to a price of the product.

Specifically, when a point 10% or 15% is provided as the bonus, the number of provided points corresponding to 10% or 15% of a price of the product will be displayed in the form of “1,200pt GET”, or the like. When the bonus is a discount of 30% off of a list price, the amount of discount is displayed in the form of “3,888 yen discount”, or the like.

FIG. 10(C) shows a product detail display screen 220 that is displayed when a product is selected in the product list display section 213 (see FIGS. 10(A) and 10(B)). The product detail display screen 220 includes a product name display section 223 for displaying a product name, a recommendation mark 224 for indicating a salon recommendation, a head office recommendation, a manufacturer recommendation, or the like, a product image display section 225 for displaying a product image, a price display section 226 for displaying a price of a product, a bonus description section 227 (bonus display section for each user type) for displaying a bonus acquired by purchasing in a sentence, a bonus display section 228 (bonus display section for each user type) for briefly displaying a bonus to be acquired, a product notification button 229 for allowing a product to be notified (advertised) to an acquaintance or a friend using an SNS or an email, and a put-in-cart button 231 for putting the product in a cart, for transfer to an order receiving functional unit 74 (product purchase receiving means, see FIG. 9).

The order receiving functional unit 74 (see FIG. 9) displays a list of products put in a shopping cart in the form of a shopping cart (not shown), and receives order operation after an order propriety determination unit 77 (purchase-without-association restriction means) determines whether the user is allowed for purchase. The order operation is executed by typical operation for requiring input of information necessary for product purchase, such as performing credit card payment and point use from a general shopping cart, inputting a shipping address of the product, and executing the order, and thus detailed description thereof is eliminated.

When receiving the order operation, the order propriety determination unit 77 (see FIG. 9) checks whether a user type of the user stored in the user data 25 (see FIG. 4) is a temporary user. When the user is a temporary user, the user is notified that the order is not acceptable and association with a salon, staff member, or a CF is required, and then an incomplete association notification screen (not illustrated) for guiding the user to a salon search screen 130 (see FIG. 7(B)) is displayed. When the user is not a temporary user, i.e., when the user is any one of a guest, a professional, an owner, and a CF, product purchase is acceptable, and thus the order receiving is continued.

Completion of the order receiving allows functions of an order-data manufacturer transfer functional unit 75 (shipping instruction processing unit) and a point sharing functional unit 76 (value sharing processing unit) shown in FIG. 9.

The order-data manufacturer transfer functional unit 75 transmits data on an orderer such as an name and an address of the orderer, data on the ordered product such as a name and quantity of the product, and delivery data such as a designated delivery date, a designated delivery time zone, and a delivery location, to a manufacturer of the ordered product. The data can be transmitted by appropriate methods as follows: when the manufacturer sets an e-mail address, the data is transmitted to the e-mail address using an email; and the data is recorded in the management database 2b of the management server 2 (see FIG. 1) and can be found out as order data when the management server 2 is accessed by the manufacturer terminal 3 (see FIG. 1). This enables the manufacturer to properly ship the ordered product.

The point sharing functional unit 76 refers to the profit sharing data 33 (see FIG. 5(C)), and when the user having purchased the product is a guest, the point sharing functional unit 76 shares a part of a sales total among the head office, the salon, the staff member, the binary, the guest, and the credit according to a sharing ratio at the time of guest's purchase, and then shares the rest to the manufacturer as the cost price of the product. When the user having purchased the product is staff member (an owner or a professional), a part of the sales total is shared among the head office, the salon, the staff member, the binary, the guest, and the credit according to a sharing ratio at the time of staff member's purchase, and the rest is shared to the manufacturer as the cost price of the product. When the user having purchased the product is a CF, the same profit sharing as the staff member is performed.

Value is shared among the head office, the salon, the staff member, the binary, and the guest by giving points of the same numerical value as the amount of money to be shared, and the head office manages the same amount of money as the points. Thus, when the points are used to require transfer of a monetary value, the points are processed such that the amount of money corresponding to the points is transferred to an account of a point recipient, or when conversion into money is operated by a user, the amount of money acquired by applying a rate of conversion into money to the points is transferred to an account of the user.

The credit is a process of paying the amount of money at a credit ratio to a credit company, and when a credit card is not used to purchase the product, an appropriate processing is performed such that the corresponding points are received by the head office or are given to the binary.

Points for the items of the head office, the salon, the staff member, the guest, and the credit in the profit sharing data 33 are unique points for which recipients are fixed. The recipients for the salon, the staff member, and the guest are determined by being associated therewith, and the recipient for the credit is determined as a credit company specified by the user at the time of ordering.

Points for the item of the binary in the profit sharing data 33 are binary points for which a recipient is not determined at that time. The binary points are shared among the head office, the salon, the staff member, and the guest at an appropriate timing using a calculation formula that is set appropriately. At this time, every salon, every staff member, and every guest can receive the binary points regardless of association. A ratio of points to be received by each of the recipients is appropriately determined using variables such as the number of new user introductions (how many associated users are introduced) and the amount of money of product purchase (how many products are purchased). In consideration of a case where a guest purchase not only a product introduced by a staff member associated with the guest, but also a product introduced by another staff member, for example, the binary points enable achieving an environment where unique points are directly given to an associated staff member and binary points are also given to other staff members to allow everyone to benefit.

FIG. 11 is a functional block diagram illustrating various functions of the salon management functional unit 63 (see FIG. 6).

When the professional-ONLY-login button 194 (see FIG. 8D) is selected, the salon management functional unit 63 (see FIG. 6) first functions in a salon management login functional unit 81 to determine whether login is acceptable by determining whether access is made by any one of an owner and a professional.

When the access is not made by the owner or the professional, the login fails and transfer processing is not performed. When the access is made by a professional or an owner managing only one salon, processing transfers to a salon-management top-screen display functional unit 83 as management of the salon associated with the professional or the owner. When the access is made by an owner managing a plurality of salons, a salon selection functional unit 82 selects which salon to be managed, and then the processing transfer to the salon-management top-screen display functional unit 83 of the selected salon.

When the login succeeds and the salon is determined in this way, the salon management top-screen display functional unit 83 functions so that a staff member-specific sales display functional unit 84, a staff member registration functional unit 85, a staff member change functional unit 86, and a guest association change functional unit 88 can be arbitrarily called to function.

The staff member-specific sales display functional unit 84 displays a list of sales for each staff member.

The staff member registration functional unit 85 (associating means) registers a user as the staff member of the salon and changes a user type in the user data 25 (see FIG. 4(A)) to the “professional”. The salon ID in the user data 25 is already associated with the salon by the invitation functional unit 51 (see FIG. 6).

The staff member change functional unit 86 (associating means) changes association of staff member with a salon. That is, when a professional moves among a plurality of salons managed by the owner, or when the professional changes a career and belongs to a different salon, a belonging salon is changed. At this time, the salon ID of the professional (user) in the user data 25 (see FIG. 4(A)) is changed to the salon ID of the newly belonging salon. At the same time, a user ID of a guest is deleted from information on the professional, stored in the attractor IDs 1, 2, . . . , in the user data 25, and an introducer ID of the guest in the user data 25 is changed to a user ID of an owner of a previous belonging salon so that the guest is associated with the previous belonging salon.

This enables only the professional to belong to the new salon while a customer remains belonging to the previous salon. When the guest likes to go to the new belonging salon of the professional, the guest and the professional belonging to the new salon need to perform again the operation of selecting inviting or being invited using the invitation functional unit 51 (see FIG. 6) to be registered again so that the salon ID of the guest is changed to the salon ID of the new salon, and the introducer ID of the guest is also changed to the user ID of the professional.

Even when a CF moves to belong to another salon, association between the CF and an introducer being a staff member using IDs is not separated because they are related to each other. Additionally, even when a guest introduced by the CF moves to another salon, association between the CF and the guest using IDs is not be separated.

The guest association change functional unit 88 (associating means) can change association of a guest in the salon. For example, when a guest being a customer of a salon, having no fixed staff member, likes one staff member and becomes a customer exclusively for the staff member, the guest association change functional unit 88 receives operation of associating the guest with the staff member. At this time, the guest association change functional unit 88 changes the user ID stored in the introducer ID of the guest in the user data 25 (which is the user ID of the owner of the salon at this point) to the user ID of the staff member to be associated with the guest, and adds the user ID of the guest to an attractor ID of the staff member in the user data 25.

As this association change, the guest can be associated with the staff member and the guest can be associated with a CF. As a result, even when an owner invites a staff member being registered as a normal guest, the guest can be associated with a professional to give the power and the bonus of a staff member to the guest, or can be associated with a CF to allow the bonus of the CF to be unnecessary.

The above configuration and operation enable providing a system capable of returning a profit to a store or/and a staff member, being in a position to propose a product, when a customer purchases the product. That is, although a guest being a customer purchases a product through the product selling value sharing system 1 through the Internet 6, associating the guest with a salon or a staff member in the purchase enables a part of the sales profit to be surely returned to the salon or the staff member.

Additionally, order data is transmitted to a manufacturer and the manufacturer directly ships the product, so that the salon can sell the product to a customer without having inventory of the product, and can receive a value share when a customer of the own salon purchases the product.

Using the product selling value sharing system 1 enables preventing a customer (guest) from purchasing a product without completely going through a store (salon) or a staff member (an owner and a professional). That is, even when a guest purchases a product through the product selling value sharing system 1 without having consciousness or operation of purchase at a salon associated with the guest itself, only purchasing the product by the guest allows a part of a profit of the product to be shared by the salon and staff member. In particular, a temporary user without association cannot purchase a product, so that a user allowed to purchase a product is always associated directly to a salon (to an owner of the salon) or indirectly thereto (through a professional or a CF). This enables solving the conventional problem in that despite introduction of a product by a salon or a staff member, purchasing the product through the Internet causes no profit of the product to be received.

All products can be sold at respective list prices within a range of price setting of a manufacturer, so that a product price cannot be changed for each salon. This enables preventing a list price and a profit rate of a product from deteriorating, so that every salon can secure a good profit rate.

Although products are provided in common by a manufacturer, a shopping screen can be shown to a guest as a sales page dedicated to a salon using the salon-specific title display section 203, the salon-specific image display section 210, and the salon data display section 219. This enables the guest to purchase a product as if the product is purchased through the Internet site dedicated to a salon visited by the guest itself, and also the salon can show the shopping screen to a customer as if it is a dedicated page.

The bonus display section 217 is displayed for each product on the product list display section 213, and the bonus description section 227 and the bonus display section 228 are displayed on the product detail display screen 220. This enables a guest, a staff member, and a CF each to purchase a product after checking a bonus given to oneself.

Points are given to a guest as a bonus, and discounts are applied to a staff member and a CF. This enables the bonus to be used to facilitate continuous transactions such as a next sale by issuing points to the guest, and enables presenting a direct merit such as discounting a product price to the staff member.

A staff member can invite a CF, so that a relative of the staff member can be registered as a relative user associated with a salon. Thus, the relative user can use shopping and the like as a user associated with the salon. The CF receives the same bonus as the staff member, so that the staff member can give a relative bonus (family bonus) to the relative, and thus the relative can receive the benefit.

When a professional invites a temporary user to be a guest, the guest is associated with the professional and the professional is associated with a salon. This enables the guest to be indirectly associated with a lower layer of the salon. Thus, an environment can be achieved where a staff member and a guest are always associated with a salon, so that a mechanism for surely returning a profit to the salon can be implemented.

The mechanism may be configured to allow regular purchase as purchase of a product. In this case, a product of the regular purchase is displayed in the product list display section 213 as for a normal product. When the product of the regular purchase is purchased, a purchase price for the first time is paid and the purchase is processed as for the normal product. From the second purchase, the same shipping, profit sharing and payment collection as in the first purchase may be performed. This case enables acquiring operational effect identical to that when a normal product is purchased, for each regular purchase.

The present invention is not limited to the present embodiment described above, and can include various other embodiments.

Although an owner and a professional are set as different user types, for example, the owner may also be registered as a professional as the user type, and the owner flag may be set to ON separately. This forms an appropriate configuration in which not only a function identical to that of the professional but also a function dedicated to the owner can be used. This case also enables acquiring similar operational effect.

Although the order propriety determination unit 77 (see FIG. 9) is configured to reject purchase by a temporary user without association, the present invention is not limited to this. The order propriety determination unit 77 may be configured such that purchase of a temporary user without association is appropriately restricted by lowering or eliminating a service at the time of purchase, for example. Examples of contents of lowering or eliminating the service at the time of purchase may include giving no point for purchase of a product, reducing the number of points, and increasing a shipping fee. This case also enables preventing the temporary user from repeatedly purchasing a product without being associated with a salon or a staff member, so that motivation for association can be enhanced.

### INDUSTRIAL APPLICABILITY

The present invention can be used in industries in which many stores provide common products.

### REFERENCE SIGNS LIST

1: Product selling value sharing system

2b: Management database

25: User data

26: Salon data

52: Inviting functional unit

53: Invited functional unit

74: Order receiving functional unit

75: Order-data manufacturer transfer functional unit

76: Point sharing functional unit

77: Order propriety determination unit

85: Staff member registration functional unit

86: Staff member change functional unit

88: Guest association change functional unit

203: Salon-specific title display

210: Salon-specific image display section

213: Product list display section

217: Bonus display section

219: Salon data display section

227: Bonus description section

228: Bonus display section

1. A product selling value sharing system comprising:
storage means for storing store data on a plurality of stores, staff member data on one or more staff members associated with the corresponding plurality of stores, customer data on a plurality of customers, and product data on a plurality of products;
associating means for associating the customers with some of the plurality of stores or staff members;
product multiple display means for allowing the plurality of products to be displayed in a user terminal that accesses the product selling value sharing system through a telecommunication line;
product purchase receiving means for receiving operation on the user terminal by the customer to purchase the corresponding products displayed by the product multiple display means,
the product purchase receiving means including
processing units that receive and implement purchase of a product by the customer and that include
a value sharing processing unit for allowing the corresponding stores or/and staff member associated with the customer, and a supplier of the product, to share at least a partial value of a price of the product, and
a shipping instruction processing unit for transmitting shipping instruction data on the product to the supplier of the product; and
purchase-without-association restriction means for restricting purchase of the customer with no association performed by the associating means when the customer tries to purchase a product using the product purchase receiving means, and the customer is not directly or indirectly associated with corresponding stores or staff member by the associating means.

2. A product selling value sharing system comprising:
storage means for storing store data on a plurality of stores, staff member data on one or more staff members associated with the corresponding plurality of stores, customer data on a plurality of customers, and product data on a plurality of products;
associating means for associating the customers with some of the plurality of stores or staff members;
product multiple display means for allowing the plurality of products to be displayed in a user terminal that accesses the product selling value sharing system through a telecommunication line; and
product purchase receiving means for receiving operation on the user terminal by the customer to purchase the corresponding products displayed by the product multiple display means,
the product purchase receiving means including
processing units that receive and implement purchase of a product by the customer and that include
a value sharing processing unit for allowing the corresponding stores or/and staff member associated with the customer, and a supplier of the product, to share at least a partial value of a price of the product, and
a shipping instruction processing unit for transmitting shipping instruction data on the product to the supplier of the product;
the storage means being configured to store relative user data allowing a relative of the staff member to be registered as a relative user,
the relative user being associated with the store associated with the staff member,
the value sharing processing unit being configured to allow the store associated with the relative user and the supplier of the product to share at least a partial value of the price of the product.

3. A product selling value sharing method comprising the steps of;
storing store data on a plurality of stores, staff member data on one or more staff members associated with the corresponding plurality of stores, customer data on a plurality of customers, and product data on a plurality of products, in storage means;
associating the customers with some of the plurality of stores or staff members using associating means;
allowing the plurality of products to be displayed in a user terminal that accesses a product selling value sharing system through a telecommunication line using product multiple display means;
receiving operation on the user terminal by the customer to purchase the corresponding products displayed by the product multiple display means, using product purchase receiving means;
implementing a process after the product purchase receiving means receives product purchase by the customer, the process including the steps of:
allowing the corresponding stores or/and staff member associated with the customer, and a supplier of the product, to share at least a partial value of a price of the product using a value sharing processing unit; and
transmitting shipping instruction data on the product to the supplier of the product using a shipping instruction processing unit; and
restricting purchase of the customer with no association performed by the associating means when the customer tries to purchase a product using the product purchase receiving means, and the customer is not directly or indirectly associated with corresponding stores or staff member by the associating means, using purchase-without-association restriction means.

4. A product selling value sharing method comprising the steps of:
storing store data on a plurality of stores, staff member data on one or more staff members associated with the corresponding plurality of stores, customer data on a plurality of customers, and product data on a plurality of products, in storage means;
associating the customers with some of the plurality of stores or staff members using associating means;
allowing the plurality of products to be displayed in a user terminal that accesses a product selling value sharing system through a telecommunication line using product multiple display means;
receiving operation on the user terminal by the customer to purchase the corresponding products displayed by the product multiple display means, using product purchase receiving means;
implementing a process after the product purchase receiving means receives product purchase by the customer, the process including the steps of:
allowing the corresponding stores or/and staff member associated with the customer, and a supplier of the product, to share at least a partial value of a price of the product using a value sharing processing unit; and
transmitting shipping instruction data on the product to the supplier of the product using a shipping instruction processing unit; and
the storage means being configured to store relative user data allowing a relative of the staff member to be registered as a relative user,
the relative user being associated with the store associated with the staff member,
the value sharing processing unit being configured to allow the store associated with the relative user and the supplier of the product to share at least a partial value of the price of the product.

5. A product selling value sharing program allowing a computer to serve as:
storage means for storing store data on a plurality of stores, staff member data on one or more staff members associated with the corresponding plurality of stores, customer data on a plurality of customers, and product data on a plurality of products;
associating means for associating the customers with some of the plurality of stores or staff members;
product multiple display means for allowing the plurality of products to be displayed in a user terminal that accesses the product selling value sharing system through a telecommunication line;
product purchase receiving means for receiving operation on the user terminal by the customer to purchase the corresponding products displayed by the product multiple display means,
the product purchase receiving means including
processing units that receive and implement purchase of a product by the customer and that include
a value sharing processing unit for allowing the corresponding stores or/and staff member associated with the customer, and a supplier of the product, to share at least a partial value of a price of the product, and
a shipping instruction processing unit for transmitting shipping instruction data on the product to the supplier of the product; and
purchase-without-association restriction means for restricting purchase of the customer with no association performed by the associating means when the customer tries to purchase a product using the product purchase receiving means, and the customer is not directly or indirectly associated with corresponding stores or staff member by the associating means.

6. A product selling value sharing program allowing a computer to serve as:
storage means for storing store data on a plurality of stores, staff member data on one or more staff members associated with the corresponding plurality of stores, customer data on a plurality of customers, and product data on a plurality of products;
associating means for associating the customers with some of the plurality of stores or staff members;
product multiple display means for allowing the plurality of products to be displayed in a user terminal that accesses the product selling value sharing system through a telecommunication line; and
product purchase receiving means for receiving operation on the user terminal by the customer to purchase the corresponding products displayed by the product multiple display means,
the product purchase receiving means including
processing units that receive and implement purchase of a product by the customer and that include
a value sharing processing unit for allowing the corresponding stores or/and staff member associated with the customer, and a supplier of the product, to share at least a partial value of a price of the product, and
a shipping instruction processing unit for transmitting shipping instruction data on the product to the supplier of the product;
the storage means being configured to store relative user data allowing a relative of the staff member to be registered as a relative user,
the relative user being associated with the store associated with the staff member,
the value sharing processing unit being configured to allow the store associated with the relative user and the supplier of the product to share at least a partial value of the price of the product.
